(19) United States
(12) Patent Application Publication
(10) Pub. No.: US 2007/0216402 A1
(43) Pub. Date: Sep. 20, 2007

(54) Sensor arrangement and shift arrangement

(76) Inventors: Uli Christian Blessing, Heilbronn (DE); Andreas Hauser, Wehingen (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/713,570

(22) Filed: Mar. 2, 2007

(30) Foreign Application Priority Data
Mar. 2, 2006 (DE) 10 2006 011 207.5

(51) Int. Cl. G01B 7/14

(52) U.S. Cl. 324/207.24

(57) ABSTRACT

A sensor arrangement for sensing at least one position of a movably mounted element in a sensing direction is disclosed. The sensor arrangement includes a magnetic arrangement which has a magnetic field distribution in the sensing direction, and includes a magnetic field sensor. The magnetic arrangement and the magnetic field sensor are arranged in such a way that the magnetic field sensor senses different magnetic field strengths in different positions of the movable element in the sensing direction. The magnetic arrangement has at least two magnets whose magnetic field distributions are combined with one another in such a way that an approximately linear characteristic curve of the sensor arrangement occurs at least over a section in the sensing direction.

### BACKGROUND

1. Field of the Invention

The present invention relates to a sensor arrangement for sensing at least one position of a movably mounted element in a sensing direction, the sensor arrangement having a magnetic arrangement which has a magnetic field distribution in the sensing direction, and a magnetic field sensor, and the magnetic arrangement and the magnetic field sensor being arranged in such a way that the magnetic field sensor senses different magnetic field strengths in different positions of the movable element in the sensing direction.

The invention also relates to a shift arrangement for shifting gear speeds of a multi-step transmission, in particular for motor vehicles, having at least one shift element which is displaceably mounted on a housing in an axial direction, and when shifting occurs is moved in the axial direction, and having a sensor arrangement for sensing at least one axial position of the shift element.

Such a shift arrangement is known from document EP 1 507 100 A2.

2. Description of the Related Technology

It is significant in shift arrangements for shifting gear speeds of a multi-step transmission, in particular if the multi-step transmission is of automatic design, that the axial position of shift elements such as shift rods is sensed axially. Such sensing allows the superordinate controller then to determine whether the shift element is for example in a neutral position or in a shifted position.

In addition, a sensor arrangement can also be used for open-loop and/or closed-loop control of the axial position and, if appropriate, of the axial movement of the shift element. In this context, the sensor arrangement can be used to make available an actual value in a closed control loop. Application to position controllers is also possible.

From the aforesaid document EP 1 507 100 A2 it is known to form a projection, in which a magnet is arranged, on a shift fork. A sensor which is fixed to the housing is used to sense the position.

Document DE 42 08 888 A1 discloses fixing a magnet to one end of a shift rod. Hall sensors are arranged on the housing at two axially offset positions. Said Hall sensors respond to the permanent magnet of the shift rod in predetermined positions of said shift rod.

A similar arrangement is known from document DE 199 61 087 A1. This document also presents an alternative arrangement in which a distance sensor for linearly variable distances (e.g. a linearly variable differential transformer: LVDT) is provided on the housing.

Document DE 37 13 880 A1 discloses a magnetic barrier with a sensor which is fixed to the housing and a magnet which is fixed to the housing and between which a shift rod can be moved through.

Document EP 1 544 511 A2 discloses a device for the manual shifting of an automatic gearbox with a complex sensor arrangement in which a three-lane magnetic arrangement with multiple north poles and south poles and an arrangement which is offset transversely and linearly with respect thereto and which is composed of at least four Hall sensors are provided. These are intended to permit a first or second shift position which differs from the central position to be sensed at least twice in order to provide a certain degree of sensing redundancy.

It is also known to secure two permanent magnets to a shift rod, specifically with opposite polarity and with a certain axial distance from one another. A magnetic field sensor is provided on the housing. The magnetic fields which are generated by the two magnets adjoin one another in the axial direction. In the centre between the two magnets, the field strength which is sensed by the magnetic field sensor is zero. Owing to the bell characteristic of the characteristic curves, the gradient of the resulting magnetic field distribution is relatively low in this central region but relatively high in other regions.

DE 197 48 115 A1 discloses a device for electromechanically shifting a change-speed transmission by means of a shift element, at least two magnets being arranged distributed over the circumference of the shift element, and a plurality of Hall sensors being arranged spaced apart from one another in the axial direction parallel to the extent of the shift element. This arrangement is intended to make it possible to sense both the shift positions and the selection positions of the shift element which is embodied as a shift shaft.

Document US 2004/0239313 A1 discloses a position sensor including a linear Hall-sensor. First and second magnets in the field assembly are positioned on a surface of a magnetic plate and separated from one another by a separation distance. The magnets have each a magnetic axis substantially transverse to the surface of the magnetic plate. The thicknesses of the magnets are selectively varied along a stroke direction, and the separation distance is selected along with a gap length distance between the magnetic sensor and the field assembly, so that a predetermined flux density versus stroke characteristic can be provided for the position sensor.

### SUMMARY OF CERTAIN INVENTIVE ASPECTS

Against the background of the abovementioned prior art, certain aspects provide a shift arrangement with a cost-effective sensor arrangement, the intention being to simplify the controller in its entirety.

In one aspect, the magnetic arrangement has at least two magnets whose magnetic field distributions are combined with one another in such a way that an approximately linear characteristic curve of the sensor arrangement occurs at least over a section in the sensing direction.

On the one hand, with the sensor arrangement it is possible to sense different axial positions with just one magnetic field sensor, for example a Hall sensor. It is not necessary to provide costly LVDT sensors.

The characteristic curve which is generally nonlinear (for example a bell-shape characteristic curve) during the interplay between a magnet and a magnetic field sensor can be combined by combining the magnetic fields of two magnets in such a way that from the point of view of the magnetic field sensor an approximately linear characteristic curve occurs. In other words, an approximately linear characteristic curve occurs which, taking into account the measurement tolerances of the magnetic field sensor, generates substantially linear output values for a subsequent control device (open-loop/closed-loop control electronics).

As a result, the control expenditure in a superordinate controller can be significantly reduced. This is because using a linear characteristic curve permits linear or substantially linear equations to be used in the controller. It is not necessary to train and/or store a nonlinear characteristic curve.

At least two magnets may be used to generate magnetic fields of different strengths.

This measure permits the characteristic curve to be linearized particularly easily.

It is furthermore advantageous if the at least two magnets are magnetized in the radial direction.

In this embodiment, the magnetic field can be sensed in an optimum way.

The at least two magnets may be arranged parallel to one another and have the same polarity.

In this embodiment, linearization of the characteristic curve of the sensor arrangement can be brought about efficiently.

It is also advantageous if the magnets are secured to the movable element and if the magnetic field sensor is secured to a housing.

Even though the arrangement can also be configured the other way round, it is advantageous to secure the magnetic field sensor to the housing. This is because the electrical connections are easy to implement in this case.

Overall it is advantageous if the section in the sensing direction has a position in which the magnetic field strength is zero or approximately zero.

On the one hand, the axial section over which the characteristic curve is linear may be made comparatively long here. In conventional sensor arrangements, the characteristic curve is frequently highly nonlinear particularly in the region of zero. However, the inventive use of two magnets permits such linearization to be achieved into the region of approximately zero.

This applies in particular if the magnetic arrangement advantageously has at least two magnets with the same polarity and at least two magnets with opposite polarity.

As a result, overall a large axial region can be obtained as a sensing region of the sensor arrangement. The use of two magnets with the same polarity on one side and the use of two magnets with opposite polarity on the other side also makes it possible to implement uniquely defined assignments of position and magnetic field strength over the entire axial region.

It is particularly advantageous here if the magnets which have the same polarity and the magnets which have opposite polarity are arranged in such a way that the linear characteristic curve has a zero crossover.

The zero crossover preferably corresponds here to a central position of the shift element or of the section in the sensing direction. In this region too, the characteristic curve is linear in the sensor arrangement according to the invention and can have a comparatively high gradient, in contrast to the prior art. This facilitates the controllability of the position of the movable element in the region of the zero crossover.

Overall it is advantageous if at least one of the magnets is a permanent magnet.

Permanent magnets have the advantage that they do not require any power supply and are maintenance-free. It is therefore easily possible to secure them to a movable element.

Alternatively it is preferred if at least one of the magnets is an electromagnet.

By means of electromagnets it is possible to combine magnetic field distributions particularly favourably, for example even by changing the current strength which is impressed on the respective magnets.

According to a further preferred embodiment, the at least two magnets are integrated in a common housing or are made available as a physical unit.

As a result, the expenditure on components can be reduced. Of course, it is possible in each case to accommodate not only two or more magnets with the same polarity in a housing but rather it is possible to accommodate an entire magnetic arrangement both with magnets with the same polarity and magnets with opposite polarity.

Owing to the linearization of the characteristic curve using at least two magnets to form the characteristic curve it is possible to implement the individual magnets at least partially as comparatively cost-effective ferrite magnets or the like. In particular it is possible, if appropriate, to dispense with what are referred to as rare earth magnets entirely or at least partially. Alternatively it is possible to use individual magnets which are significantly more compact overall instead of the relatively large magnets from the prior art. Of course, the respective magnetic arrangement can contain more than two magnets, for example three, four or even more magnets.

According to other preferred embodiment, the magnetic arrangement comprises at least three magnets, wherein the magnets have faces that face to the magnetic field sensor, and wherein the faces of the three magnets, in a section along the sensing direction, together form the shape of a curve.

According to a second aspect of the present invention, a sensor arrangement for sensing at least one position of a moveably mounted element in a sensing direction, the sensor arrangement having a magnetic arrangement which has a magnetic field distribution in the sensing direction, and a magnetic field sensor, and the magnetic arrangement and the magnetic field sensor being arranged in such a way that the magnetic field sensor senses different magnetic field strengths in different positions of the moveable element in the sensing direction, wherein the magnetic arrangement comprises a face facing to the magnetic field sensor, wherein the face, in a section along the sensing direction, comprises the shape of a curve.

While the prior art according to US 2004/0239313 A1 proposes a linear plane face in order to achieve a linearization of the characteristic, the second aspect of the invention proposes to form this face in the shape of a curve.

Such curve shape facilitates a linearization of the characteristic in a multiplicity of applications, wherein a linear shape of the face is only suitable for some applications.

It is of particular preference, if the curve shape comprises the shape of a potential function, particularly a parabolic shape.

Such shape can lead to a particularly good linearization. However, it is also conceivable to provide as the curve shape the shape of an exponential function (e function), a root function or a logarithmic function.

It is particularly preferred if the distance between the sensor arrangement and the face is larger than 0.5 mm.

While the construction with linear faces according to the above-cited prior art appears possible particularly for short distances between the face and the magnet field sensor, the proposed curve shape according to the invention provides particularly with larger distances a good linearization of the characteristic.

It is further preferred if the distance between the sensor arrangement and the face is larger than 1.0 mm.

Also, it is preferred if the magnetic arrangement is formed by an integral single permanent magnet.

Such integral single permanent magnet can be manufactured for instance by a sintering method (by pressing in molds). Here, the shapes of the magnetic arrangement can be chosen rather freely. As an alternative, it is also conceivable to mix magnetic dust into plastic material. With this alternative, it is possible to achieve arbitrary shapes, e.g. by injection molding.

Generally, it is also conceivable to achieve the curve shape by a plurality of three or more magnets which are arranged side by side in the sensing direction.

In total, at least one of the following advantages is achieved:

A linear characteristic curve permits more simple closed-loop and/or open-loop control algorithms to be used.

If use is made of magnets which have the same polarity and magnets which have opposite polarity it is possible to achieve a relatively high gradient in the linear region.

It is possibly not necessary to use rare earth magnets even though the use of rare earth magnets is not intended to be excluded according to the invention.

Since the characteristic curve is essentially linear, a training strategy is not necessary to determine the dependence of the position and magnetic field. Instead this results on the basis of the linear characteristic curve.

Since the individual magnets which are used can each be made weaker, it is possible to reduce interference fields which can in particular have an adverse effect on the surroundings sensor system.

It is not necessary to store a nonlinear characteristic diagram in the memory of a control device.

Of course, the features which are mentioned above and which are to be explained below can be used not only in the respectively specified combination but also in other combinations or alone without departing from the scope of the present invention.

### BRIEF DESCRIPTION OF THE SEVERAL VIEWS OF THE DRAWINGS

Exemplary embodiments of the invention are illustrated in the drawing and will be explained in more detail in the following description.

FIG. 1 is a schematic illustration of a shift arrangement according to an embodiment;

FIG. 2 is a characteristic curve of the sensor arrangement of a shift arrangement in the form of a diagram of the magnetic field strength plotted against the travel;

FIG. 3 is a schematic illustration of a sensor arrangement according to a further embodiment;

FIG. 4 is a schematic illustration of an alternative arrangement of a magnetic arrangement for a sensor arrangement;

FIG. 5 is a schematic illustration of a shift arrangement according to an alternative embodiment; and

FIG. 6 is a diagram with different curve functions that are suitable for realizing the shape of the faces of the magnetic arrangement of the shift arrangement of FIG. 5.

### DETAILED DESCRIPTION OF THE INVENTION

In FIG. 1, a multi-step transmission for a motor vehicle gearbox is illustrated in schematic form and designated generally by 10.

The multi-step transmission 10 has an input shaft (not designated in more detail), a countershaft 12 and an output shaft 14.

In addition, the multi-step transmission 10 has a plurality of wheel sets, of which only one is shown (indicated by 16) in FIG. 1 for reasons of clear illustration.

In the multi-step transmission 10, a wheel set corresponds to one gear speed here. In order to put the wheel set 16 into the power flow, a first clutch 18 is provided, for example in the form of a conventional synchronizer clutch. The clutch 18 can be activated by means of a slider sleeve 20 which is mounted on the output shaft 14 in an axially displaceable fashion.

The slider sleeve 20 is also configured to activate a second clutch 19 for a further wheel set.

In order to move the slider sleeve 20 and thus to activate the clutches 18, 19, a shift arrangement according to the present invention is provided, and this is designated generally by 30 in FIG. 1.

The shift arrangement 30 has a shift element 32 in the form of a shift rod. A shift element in the form of a shift fork 34 is secured to the shift rod 32.

In one axial direction 35, the shift rod 32 is mounted in a displaceable fashion on a schematically illustrated housing 36. In addition, the shift rod 32 can be connected to an actuator (not illustrated), for example a hydraulic actuator or an electromechanical actuator.

The shift element 34 engages with a circumferential groove of the slider sleeve 20. Axial displacement of the shift rod 32 consequently causes the slider sleeve 20 to be displaced axially.

The multi-step transmission 10 is preferably an automatic manual transmission, a double clutch transmission or the like. The shift arrangement 30 according to the invention can however also be applied to other types of transmissions, for example to IVT transmissions etc.

In order to sense the axial position of the shift rod 32 a sensor arrangement 37 according to the invention is provided.

The sensor arrangement 37 has a first magnetic arrangement 38 and a second magnetic arrangement 40. The two magnetic arrangements 38, 40 are secured to the shift rod 32, offset in the axial direction and preferably symmetrically with respect to an axial central position M.

The first magnetic arrangement 38 has a first magnet 42 which generates a first magnetic field 43, and a second magnet 44 which generates a second magnetic field 45.

In a corresponding way, the second magnetic arrangement 40 has a third magnet 46 which generates a third magnetic field 47, and a fourth magnet 48 which generates a fourth magnetic field 49.

In the central position M, a magnetic field sensor 50, embodied here as a Hall sensor, is secured to the housing 36.

The magnets 42, 44, 46, 48 are each embodied as permanent magnets. They are secured to the shift rod 32 in such a way that their respective north/south axes are oriented radially (in other words the magnets are magnetized radially).

The first magnet 42 and the second magnet 44 of the first magnetic arrangement 38 have the same polarity, the first magnet 42 being a stronger magnet which generates a relatively strong magnetic field.

In a corresponding way, the third magnet 46 and the fourth magnet 48 of the second magnetic arrangement 40 have the same polarity, but opposed to that of the magnets 42, 44 of the first magnetic arrangement 38.

The fourth magnet 48 is less strong than the third magnet 46. The less strong magnets 44, 48 of the magnetic arrangements 38, 40 are turned towards one another.

The different strengths of the magnets 42, 44 and 46, 48 can be implemented by virtue of the fact that the magnets are magnetized with different strengths, by virtue of the fact that the magnets are of different sizes and/or by virtue of the fact that the magnets are of a different type. The illustration with a different overall size is selected merely by way of example in FIG. 4.

The sensor arrangement 30 serves, for example, to feed-back control the position of the shift rod 32 to the central position M. On the other hand, the sensor arrangement 30 serves to sense if the shift rod 32 is in a first shift position S1 in which the first clutch 18 is closed, or in a second shift position S2 in which the second clutch 19 is closed.

For this purpose, the magnetic field sensor 50 is connected to a control device 52 which carries out the aforesaid control tasks.

Although the first and second magnetic arrangements 38, 40 in FIG. 1 each have two magnets 42, 44 and 46, 48, the magnetic arrangements can of course also each have more than two magnets, for example three, four or more magnets, arranged offset in the axial direction on the shift rod 32.

One factor is that within one magnetic arrangement 38, 40 at least two magnets 42, 44 and 46, 48 are combined with one another in such a way that an approximately linear characteristic curve of the sensor arrangement is obtained at least over an axial section.

The characteristic curve which is generally nonlinear (for example a bell-shape characteristic curve) during the interplay between a magnet and a magnetic field sensor can be combined by combining the magnetic fields of two magnets in such a way that from the point of view of the magnetic field sensor an approximately linear characteristic curve occurs. In other words, an approximately linear characteristic curve occurs which, taking into account the measurement tolerances of the magnetic field sensor, generates substantially linear output values for a subsequent control device (open-loop/closed-loop control electronics).

As a result, the control expenditure in a superordinate controller can be significantly reduced. This is because using a linear characteristic curve permits linear or substantially linear equations to be used in the controller. It is not necessary to train and/or store a nonlinear characteristic curve.

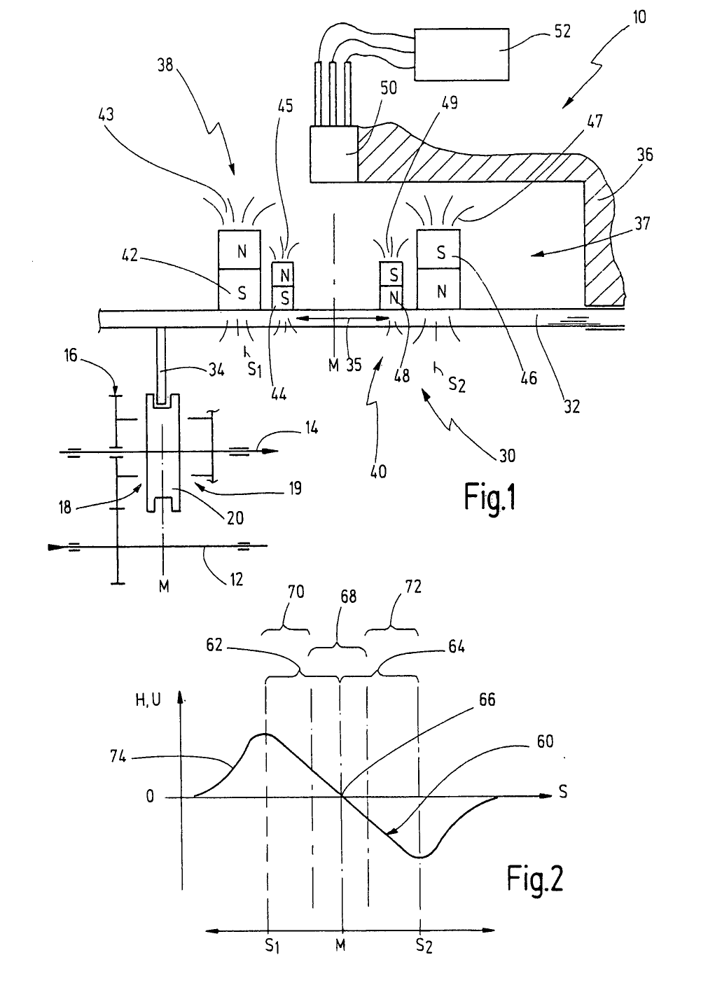

FIG. 2 is an illustration of a magnetic field distribution 60 obtained with the sensor arrangement 30 in FIG. 1, in the form of a diagram of magnetic field strength H plotted against the travel s.

The characteristic curve 60 is based on the two typical bell-shaped magnetic field distributions of a permanent magnet such as are found to occur with a magnetic field sensor such as a Hall sensor. The illustration in FIG. 2 corresponds to that field strength H sensed by the magnetic field sensor 50, plotted against the travel s, the central position M and the two shift positions S1, S2 being illustrated.

In a conventional combination of two magnets with different polarity, a variable gradient is obtained in particular in the region of the central position, said gradient becoming virtually zero in the central position (positive gradient approximately zero). The combination of the magnets 42, 46 with in each case one further magnet 44 or 48 which is of the same polarity allows the region between the two peak values S1, S2 to be linearized continuously. In other words, a linear characteristic curve of the field which is sensed by the magnetic field sensor 50 (proportional to the resulting voltage U) plotted against the travel s is produced over the entire section from the shift position S1 to the shift position S2.

In the region of the central position M, the magnetic field distribution 60 has a zero crossover 66, a first linear region 62 in the positive direction adjoining towards the first shift position S1, and a second linear region 64 adjoining in the negative direction towards the second shift position S2. Accordingly, a uniquely defined field strength or voltage can be assigned to each travel position s over the entire region 62, 64.

A central region around the central position M is shown as a control region 68 within which the position of the shift rod 32 can be feed-back controlled to the central position M. To the left and right of this, control regions 70, 72 are shown, within which control regions 70, 72 the clutches 18, 19 can be opened or closed in a controlled fashion.

Particularly in the control region 68, the curve 60 has a relatively large gradient so that the controllability is improved.

To be more precise, better resolution of the sensor signal is obtained.

To the left and right of the entire sensing region, composed of the control region 68 and the control regions 70, 72, the magnetic field distribution or curve is in each case bell-shaped, as caused by an individual magnet. In this region, the influence of the additional magnets 44, 48 is relatively small in each case. It is apparent that these bell-shaped regions 74 approach zero in a nonlinear asymptotic fashion so that the gradient also becomes virtually zero in the region of a field strength of zero.

In the embodiment described above a zero crossover is set up in the central position M. However, it is also possible to arrange the magnetic arrangements 42, 44 and 46, 48 in such a way that a zero crossover lies outside the central position M.

Although the invention has been described with reference to an exemplary embodiment, the invention is of course not restricted to this exemplary embodiment.

Thus, instead of the described transmission it is possible to apply the invention to different types of transmissions, for example automatic manual transmissions, double clutch transmissions etc. In addition, it is also possible to apply it to other types of transmissions, for example IVTs or even axially moving parts in torque-converter transmissions etc.

It is also possible to use the sensor arrangement according to the invention not only in transmissions but also in other fields of application in which it is necessary to sense a position in a sensing direction.

The sensing direction is, as in the above exemplary embodiment, preferably an axial direction. However, it is also possible to use the entire arrangement for radial sensing directions or for sensing processes in the circumferential direction. In the latter case, it would be possible, for example, for a magnetic arrangement to be composed of at least two sensors which are arranged adjacent to one another in the circumferential direction of a rotatably mounted element so that there is an approximately linear characteristic curve of a magnetic field sensor in the circumferential direction.

In addition, application in transmissions is possible not only in the region of shift elements. Instead it is also possible to use the sensor arrangement according to the invention in parking locks (for sensing parking lock positions), in clutches (for sensing clutch positions) etc.

The magnets 42, 44, 46, 48 can each be embodied as ferrite magnets even though it is also conceivable to embody the magnets at least partially as rare earth magnets.

Generally, it is of course also possible to embody the magnets as electromagnets.

Instead of a Hall sensor 50 it is also possible to use a different magnetic field sensor.

Generally it is also possible to secure the magnetic field sensor to the movable element and to secure the magnets to a housing.

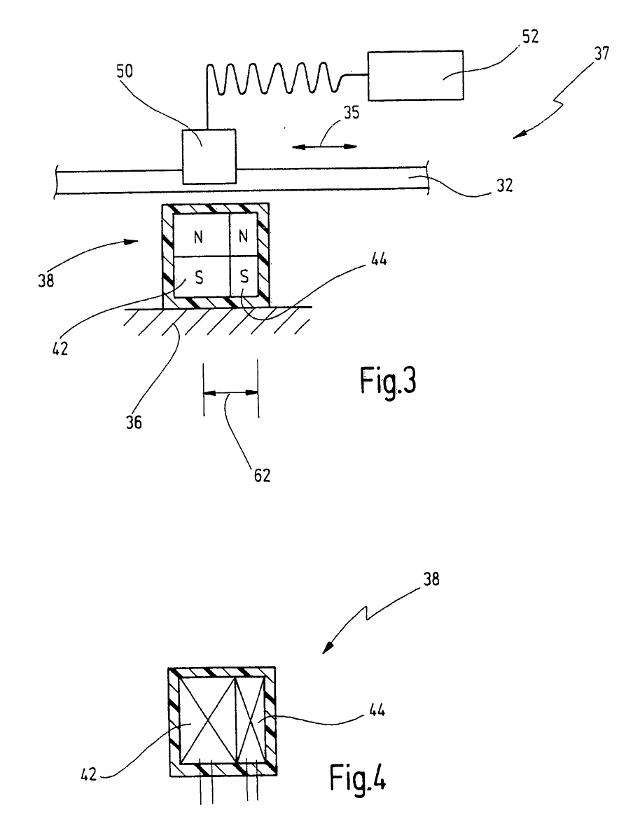

Such an exemplary embodiment of a sensor arrangement according to the invention is shown in FIG. 3. The arrangement shown in FIG. 3 corresponds generally to the sensor arrangement 37 in FIGS. 1 and 2 in terms of design and method of functioning. For this reason, the same elements have been provided with the same reference numbers. In the text which follows, details are given only on differences.

In the sensor arrangement 37 in FIG. 3, the Hall sensor is secured to an element 32 which is movably mounted in an axial direction 35. The Hall sensor 50 is connected, for example, to a control device 52 via a flexible line arrangement.

A magnetic arrangement 38 is secured to a housing 36. The magnetic arrangement 38 has a first magnet 42 and a second magnet 44 whose characteristic curves complement one another to form a linear characteristic curve from the point of view of the magnetic field sensor 50. The two magnets 42, 44 are integrated here in a common housing (not designated in more detail) so that they can be used and mounted as one component.

The linear sensing section 62 is embodied without a zero crossover in the sensor arrangement 37 in FIG. 3, but it can extend to approximately zero or to zero. Of course, in the sensor arrangement 37 in FIG. 3 it is possible to provide a further unit composed of at least two magnets in order to obtain a linear characteristic curve with a zero crossover, similar to the embodiment in FIG. 1.

The housing in which the two magnets 42, 44 are embedded can be manufactured from a plastic. Of course, such a housing can also be provided in the embodiment in FIG. 1.

FIG. 4 shows an alternative embodiment of a magnetic arrangement with a first magnet 42 and a second magnet 44. In contrast to the magnets 42, 44 of the sensor arrangements 37 in FIGS. 1 to 3 (which are embodied as permanent magnets), the magnets 42, 44 of the magnetic arrangement 38 in FIG. 4 are embodied as electromagnets.

The electromagnets can preferably be actuated separately from one another. As a result, the characteristic curve can, for example, also be linearized by influencing the strength of the current which is respectively impressed on the two magnets 42, 44.

Alternatively it is also possible to implement the two electromagnets by means of two windings which are located serially one behind the other and which have, for example, a different number of turns and/or extent. In the latter case, only a single current is conducted through the two magnets 42, 44.

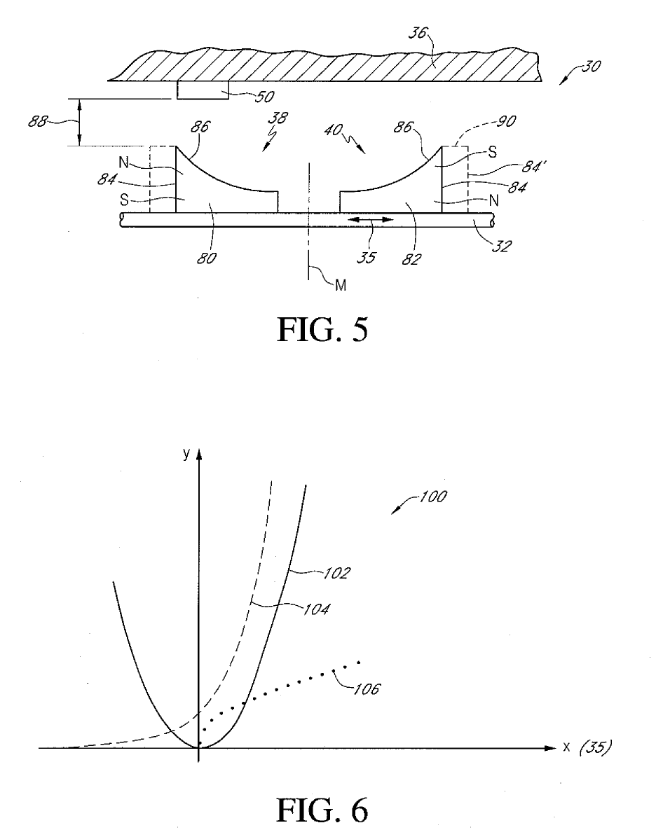

FIG. 5 is a schematic illustration of a shift arrangement 30 according to an alternative embodiment of the present invention. The shift arrangement 30 of FIG. 5 corresponds with respect to construction and with respect to the function thereof in general to the shift arrangement 30 of FIG. 1. In the following, only differences are addressed.

The shift arrangement 30 of FIG. 5 comprises a first magnetic arrangement 38 and a second magnetic arrangement 40, which are secured to a shift rod 32, offset in the axial direction, preferably symmetrically with respect to an axial central position M.

The magnetic arrangements 38, 40 are in each case formed as a permanent magnet. Specifically, each of the permanent magnets 38, 40 is integrally formed, e.g. by a sintering method, by a plastic injection molding method with magnetic particles mixed into the plastic, or by similar methods.

Thus, the first magnetic arrangement 38 is formed by a permanent magnet 80, and the second magnetic arrangement 40 by a second magnet 82. The permanent magnets 80, 82 are magnetized in a radial direction, so that in each case an axis connecting the north pole N and the south pole S is generally arranged transverse with respect to the sensing direction 35.

The magnets 80, 82 comprise side surfaces that are facing to each other, which side surfaces are not designated in FIG. 5. On the other hand, the magnets 80, 82 comprise side surfaces 84 that are opposite to each other in the sensing direction 35. The faces 86 of the magnets 80, 82 are each formed with the shape of a curve, preferably according to a parabolic shape (like in an x² function). The curve shape is based preferably on a mathematical function, specifically from a suitably chosen portion of such mathematical function (particularly potential (power function)).

The curve shape of the faces 86 is chosen such that the highest point of the curve in radial direction, i.e. the point of the curve shape that is located closest to the magnetic field sensor, is arranged in the area of the respective side surfaces 84. The curve shapes of the faces 86 are further chosen such that the curves, in direction to the respective other magnet, depart increasingly from the magnetic field sensor 50, down to the side surfaces that face to each other.

The shortest distance between the faces 86 and the magnetic field sensor 50 is designated with reference numeral 88 in FIG. 5. The distance 88 is, in a preferred embodiment, at least 0.5 mm, particularly 1.0 mm or more, as e.g. 3 mm±1 mm.

The curve shape of the faces 86 facilitates the linearization of the characteristic of the sensor arrangement 30, particularly at larger distances 88 (within the above-mentioned ranges). Further, such a curve shape makes the sensor arrangement generally more insensitive against tolerances of the distance 88. Particularly when being used in step transmissions, this is of particular relevance, as one would calculate with larger tolerances of the mounting position of the shift rod 32 in relation to the housing 36, e.g. in a range of at least 20% of the target distance 88.

Further, it is shown in FIG. 5 that portions of the faces 86 of the magnets 80, 82 can be formed with a plane shape at the opposite ends thereof, as is shown by dashed lines in FIG. 5. The corresponding plane face portion is designated with reference numeral 90 in FIG. 5. The side surface which is, thus, displaced with respect to the curve shape in the sensing direction 35, is designated with 84′ in FIG. 5.

FIG. 6 is a diagram comprising several mathematical potential (power) functions that are suitable for forming the curve shape of the faces 86. For instance, a parabolic function like an x² function is shown at 102. At 104 an exponential function (e function) is shown, and a root function is shown at 106. It is to be understood that in each case a suitable portion in x direction can be used for forming the curve shape. Further, it is to be understood that other mathematical functions can be used for forming the curve shape, like e.g. logarithmic functions, trigonometric functions, etc.

What is claimed is:

1. A sensor arrangement configured to sense at least one position of an element, movable between at least two positions in a sensing direction, the sensor arrangement comprising:
a plurality of magnets configured to cause a magnetic field distribution in the sensing direction; and
a magnetic field sensor, wherein the plurality of magnets and the magnetic field sensor are arranged such that the magnetic field sensor is configured to sense a magnetic field strength, the magnetic field strength depending at least in part on a position of the movable element,
wherein the at least a section of the magnetic field distribution of the plurality of magnets is described by an approximately linear characteristic curve in the sensing direction.

2. The sensor arrangement according to claim 1, wherein the plurality of magnets are configured to generate magnetic fields of different strengths.

3. The sensor arrangement according to claim 1, wherein the plurality of magnets are magnetized in the radial direction.

4. The sensor arrangement according to claim 1, wherein the plurality of magnets are arranged parallel to one another and have the same polarity.

5. The sensor arrangement according to claim 1, wherein the plurality of magnets are secured to the movable element, wherein the magnetic field sensor is secured to a housing.

6. The sensor arrangement according to claim 1, wherein the section of the magnetic field distribution has a magnetic field strength of zero or approximately zero.

7. The sensor arrangement according to claim 1, wherein the plurality of magnets comprises at least two magnets with the same polarity and at least two magnets with opposite polarity.

8. The sensor arrangement according to claim 7, wherein the at least two magnets which have the same polarity and the at least two magnets which have opposite polarity are arranged in such a way that the approximately linear characteristic curve has a zero crossover.

9. The sensor arrangement according to claim 8, wherein the zero crossover is located in the centre of the section of the magnetic field distribution.

10. The sensor arrangement according to claim 1, wherein at least one of the plurality of magnets is a permanent magnet.

11. The sensor arrangement according to claim 1, wherein at least one of the plurality of magnets is an electromagnet.

12. The sensor arrangement according to claim 1, wherein the plurality of magnets comprises at least two magnets integrated into a common housing.

13. The sensor arrangement according to claim 1, wherein the plurality of magnets comprises at least three magnets, wherein the three magnets have faces that face toward the magnetic field sensor, and wherein the faces of the three magnets, in a portion of the sensing direction, together form the shape of a curve.

14. The sensor arrangement according to claim 13, wherein the curve has the shape of a potential function.

15. The sensor arrangement according to claim 14, wherein curve has a parabolic shape.

16. The sensor arrangement according to claim 13, wherein the distance between the sensor arrangement and at least one of the faces is larger than 0.5 mm.

17. The sensor arrangement according to claim 13, wherein the distance between the sensor arrangement and at least one of the faces is larger than 1.0 mm.

18. The sensor arrangement according to claim 13, wherein the plurality of magnets comprises an integral single permanent magnet.

19. A sensor arrangement configured to sense at least one position of an element, movable between at least two positions in a sensing direction, the sensor arrangement comprising:
a plurality of magnets configured to cause a magnetic field distribution in the sensing direction; and
a magnetic field sensor, wherein the plurality of magnets and the magnetic field sensor are arranged such that the magnetic field sensor is configured to sense a magnetic field strength, the magnetic field strength depending at least in part on a position of the movable element, wherein the plurality of magnets comprises a face facing toward the magnetic field sensor, and
wherein the face, in a section along the sensing direction, comprises the shape of a curve.

20. The sensor arrangement according to claim 19, wherein the curve has the shape of a potential function.

21. The sensor arrangement according to claim 20, wherein the curve has a parabolic shape.

22. The sensor arrangement according to claim 19, wherein the distance between the magnetic field sensor and the face is larger than 0.5 mm.

23. The sensor arrangement according to claim 19, wherein the distance between the magnetic field sensor and the face is larger than 1.0 mm.

24. The sensor arrangement according to claim 19, wherein plurality of magnets comprises an integral single permanent magnet.

25. The sensor arrangement according to claim 19, wherein the movable element is displaceably mounted in the axial direction, and the sensing direction is the axial direction.

26. A shift arrangement configured to shift gear speeds of a multi-step transmission, the shift arrangement comprising:
at least one shift element which is displaceably mounted on a housing, the shift arrangement configured such that when shifting occurs, the shift element is moved in an axial direction; and
a sensor arrangement configured to sense at least one position of the movable shift element, the sensor arrangement comprising:
a plurality of magnets configured to cause a magnetic field distribution in the sensing direction; and
a magnetic field sensor, wherein the plurality of magnets and the magnetic field sensor are arranged such that the magnetic field sensor is configured to sense a magnetic field strength, the magnetic field strength depending at least in part on a position of the movable element,
wherein the at least a section of the magnetic field distribution of the plurality of magnets is described by an approximately linear characteristic curve in the sensing direction.

27. A shift arrangement for configured to shift gear speeds of a multi-step transmission, the shift arrangement comprising:
at least one shift element which is displaceably mounted on a housing, the shift arrangement configured such that when shifting occurs, the shift element is moved in an axial direction; and
a sensor arrangement configured to sense at least one position of the movable shift element, the sensor arrangement comprising:
a plurality of magnets configured to cause a magnetic field distribution in the sensing direction; and
a magnetic field sensor, wherein the plurality of magnets and the magnetic field sensor are arranged such that the magnetic field sensor is configured to sense a magnetic field strength, the magnetic field strength depending at least in part on a position of the movable element,
wherein the plurality of magnets comprises a face facing toward the magnetic field sensor, and
wherein the face, in a section along the sensing direction, comprises the shape of a curve.
